(19) United States
(12) Patent Application Publication
(10) Pub. No.: US 2017/0238149 A1
(43) Pub. Date: Aug. 17, 2017

(54) NETWORK SHARING FOR MULTIMEDIA BROADCAST MULTICAST SERVICE

(71) Applicant: NOKIA SOLUTIONS AND NETWORKS OY, Espoo (FI)

(72) Inventors: Xiang XU, Nanjing, Jiangsu (CN); Henri Markus KOSKINEN, Espoo (FI); Manivannan THYAGARAJAN, Coppell, TX (US)

(73) Assignee: NOKIA SOLUTIONS AND NETWORKS OY, Espoo (FI)

(21) Appl. No.: 15/502,526

(22) PCT Filed: Aug. 8, 2014
(86) PCT No.: PCT/EP2014/067110

§ 371 Date: Feb. 8, 2017

(51) Int. Cl. H04W 4/06; H04W 24/10

(52) U.S. Cl. CPC H04W 4/06; H04W 24/10; H04W 84/042

(57) ABSTRACT

The present invention addresses methods, apparatus and computer program product for enhanced network sharing with Multimedia Broadcast Multicast Service. Thereby, a mechanism is provided that allows for the information relating to the different IDs used to be provided from a base station to a Multi-cell/multicast Coordination Entity so that the appropriate routing can be determined. The Multi-cell/multicast Coordination Entity may provide the Mobility Management Entity with this information so that control signaling can be properly distributed based on this information and the at least one MBMS SAI. According to the inven tion, a base station indicates one or more PLMN IDs for at least one MBMS SAI to the MCE.

### FIELD OF THE INVENTION

The present invention generally relates to wired and wireless communication networks, and more specifically relates to a method, apparatus and computer program product for enhanced network sharing with Multimedia Broadcast Multicast Service MBMS.

### BACKGROUND

Mobile data transmission and data services are constantly making progress, wherein such services provide various communication services, such as voice, video, packet data, messaging, broadcast, etc. In recent years, Long Term Evolution LTE^{TM} has been specified, which uses the Evolved Universal Terrestrial Radio Access Network E-UTRAN as radio communication architecture according to 3GPP specification.

According to 3GPP cellular networks, a point-to-multipoint functionality has been designed for providing efficient delivery of broadcast and multicast services, both within a cell as well as within the core network. This functionality is also known as Multimedia Broadcast Multicast Service MBMS. Target applications for this technology include e.g. mobile TV and radio broadcasting, as well as file delivery and emergency alerts.

In particular, as is also depicted in FIG. 1 by means of a schematic reference architecture for conventional evolved packet service (EPS) MBMS according to the document 3GPP TS23.246 (“Multimedia Broadcast/Multicast Service (MBMS); Architecture and functional description”), a MBMS service is defined as a point-to-multipoint service in which data is transmitted from a single source entity to multiple recipients. Transmitting the same data to multiple recipients allows network resources to be shared. A base station (i.e. evolved NodeB) eNB is served by a single Multi-cell/multicast Coordination Entity MCE.

Further, document 3GPP TS23.003 (“Numbering, addressing and identification”) defines that a cell shall be able to belong to one or more MBMS Service Areas (SAs), and is therefore configured with one or more MBMS Service Area Identifications (SAIs). Each MBMS SAI shall be a decimal number between 0 and 65,535 (inclusive). The value 0 has a special meaning; it shall denote the whole Public Land Mobile Network PLMN as the MBMS Service Area and it shall indicate to a receiving RNC/BSS/MCE that all cells reachable by that RNC/BSS/MCE shall be part of the MBMS Service Area.

With the exception of the specific MBMS Service Area Identity with value 0, the MBMS Service Area Identity shall be unique within a Public Land Mobile Network PLMN and shall be defined in such a way that all the corresponding cells are MBMS capable.

According to the prior art, during the M2 Setup procedure and the eNB Configuration Update procedure, the eNB informs MCE about its supported SAI. Similarly, the MCE informs MME about its supported SAI during the M3 Setup procedure, and the MCE Configuration Update procedure.

The MBMS Session Control signaling (i.e. MBMS Start/Update Req message) contains the MBMS SAIs. When connected to multiple MCEs, the MME should filter the distribution of Session Control message to the MCEs based on the MBMS service area; The MCE forwards the MBMS Session control signaling to all eNBs that support the MBMS SAIs as indicated in the MBMS Session control signaling.

During the MBMS session start procedure, the MCE may pre-empt ongoing MBMS services in order to establish the radio resource for the new MBMS service when the radio resources are not sufficient and the new MBMS service has higher priority. The prior art session start procedure according to 3GPP TS36.300 is shown in FIG. 2.

Additionally, document 3GPP TS23.251 (“Network Sharing; Architecture and functional description”) defines two architectures for network sharing. In both architectures, the radio access network is shared. FIG. 3a shows a reference architecture for network sharing in which also Mobile Switching Centers MSCs and Serving GPRS support node SGSNs are shared. This configuration will be referred to as a Gateway Core Network (GWCN) configuration. As becomes apparent from FIG. 3a, besides of shared radio access network nodes, the core network operators also share core network nodes. Furthermore, FIG. 3b shows the reference architecture for network sharing in which only the radio access network is shared, i.e. the Multi-Operator Core Network (MOCN) configuration.

Still further, according to document 3GPP RP-141035 (“Group Call eMBMS congestion management”), it is required for the RAN to report the status information to core network. The status could be the RAN is congested or failure, or recovery from the congestion or failure. Based on the status information, the core network may take corresponding actions, e.g. move the GCSE service to unicast, or move the GCSE service back to MBMS, etc.

However, according to the known configuration, the MBMS SAI is unique within a PLMN. Even if the operators may coordinate the MBMS SAIs for the shared MBMS service area, it is not required for operators to coordinate all MBMS SAIs for those non-shared MBMS service area.

In particular, since MBMS SAIs are unique within one PLMN and while some coordination of SAIs is possible, such as in shared MBMS service areas, problems can occur when coordinating shared and non-shared MBMS service areas, as SAIs used in different networks but have identical values can cause routing problems, as the destination can be unclear due a mix up caused by multiple identical SAIs.

Hence, in view of the above drawbacks, there is a need for improving network sharing with MBMS.

### SUMMARY OF THE INVENTION

Therefore, in order to overcome the drawbacks of the prior art, it is an object underlying the present invention to provide improved network sharing for MBMS functionality.

In particular, it is an object of the present invention to provide a method, apparatus and computer program product for enhanced network sharing with Multimedia Broadcast Multicast Service MBMS.

According to a first aspect of the present invention, there is provided a method performed in a base station of a mobile network, comprising determining one or more Public Land Mobile Network Identities for at least one Multimedia Broadcast Multicast Service Service Area Identity supported in a cell, composing a message comprising information indicating the determined one or more supported Public Land Mobile Network Identities for the at least one Multimedia Broadcast Multicast Service Service Area Identity supported in the cell, and transmitting the message.

According to a second aspect of the present invention, there is provided an apparatus comprised in a base station of a mobile network, comprising a determination unit configured to determine one or more Public Land Mobile Network Identities for at least one Multimedia Broadcast Multicast Service Service Area Identity supported in a cell, a composition unit configured to compose a message comprising information indicating the determined one or more supported Public Land Mobile Network Identities for the at least one Multimedia Broadcast Multicast Service Service Area Identity supported in the cell, and a processing unit configured to cause transmission of the message to a Multi-cell/multicast Coordination Entity.

According to a third aspect of the present invention, there is provided a method performed in a Multi-cell/multicast Coordination Entity, comprising receiving a message from a base station, the message comprising information indicating one or more supported Public Land Mobile Network Identities for at least one Multimedia Broadcast Multicast Service Service Area Identity, composing a message comprising information indicating the received information about the one or more supported Public Land Mobile Network Identities for the at least one Multimedia Broadcast Multicast Service Service Area Identity, and transmitting the composed message to a Mobility Management Entity.

According to a fourth aspect of the present invention, there is provided an apparatus comprised in a Multi-cell/multicast Coordination Entity, comprising a reception unit configured to receive a message from a base station, the message comprising information indicating one or more supported Public Land Mobile Network Identities for at least one Multimedia Broadcast Multicast Service Service Area Identity, a composition unit configured to compose a message comprising information indicating the received information about the one or more supported Public Land Mobile Network Identities for the at least one Multimedia Broadcast Multicast Service Service Area Identity, and a processing unit configured to cause transmission of the composed message to a Mobility Management Entity.

According to a fifth aspect of the present invention, there is provided a method performed in a Mobility Management Entity, comprising receiving a message from a Multi-cell/multicast Coordination Entity, the message comprising information indicating one or more Public Land Mobile Network Identities for at least one Multimedia Broadcast Multicast Service Service Area Identity supported in a Multi-cell/multicast Coordination Entity, and filtering distribution of Session Control signaling to respective Multi-cell/multicast Coordination Entities based on the at least one Multimedia Broadcast Multicast Service Service Area Identity and the one or more Public Land Mobile Network Identities.

According to a sixth aspect of the present invention, there is provided an apparatus comprised in a Mobility Management Entity, comprising a reception unit configured to receive a message from a Multi-cell/multicast Coordination Entity, the message comprising information indicating one or more Public Land Mobile Network Identities for at least one Multimedia Broadcast Multicast Service Service Area Identity supported in a Multi-cell/multicast Coordination Entity, and a filter unit configured to filter distribution of Session Control signaling to respective Multi-cell/multicast Coordination Entities based on the at least one Multimedia Broadcast Multicast Service Service Area Identity and the one or more Public Land Mobile Network Identities.

According to a seventh aspect of the present invention, there is provided a method performed in a user equipment, comprising receiving an indication of one or more supported Public Land Mobile Network Identities for at least one Multimedia Broadcast Multicast Service Service Area Identity supported in at least one cell, and taking action based on the at least one supported Multimedia Broadcast Multicast Service Service Area Identity and at least in part on the received indication of the one or more supported Public Land Mobile Network Identities.

According to a eighth aspect of the present invention, there is provided an apparatus comprised in a user equipment, comprising a reception unit configured to receive an indication of one or more supported Public Land Mobile Network Identities for at least one Multimedia Broadcast Multicast Service Service Area Identity supported in at least one cell, and a processing unit configured to take action based on the at least one supported Multimedia Broadcast Multicast Service Service Area Identity and at least in part on the received indication of the one or more supported Public Land Mobile Network Identities.

According to a ninth aspect of the present invention, there is provided a computer program product comprising computer-executable components which, when the program is run, are configured to carry out the method according to the first, the third, the fifth or the seventh aspect.

Advantageous further developments or modifications of the aforementioned exemplary aspects of the present invention are set out in the dependent claims.

According to certain embodiments of the present invention in regard of the first and second aspect, a status report is composed in case of an error during Multimedia Broadcast Multicast Service session start or in case of a detected congestion/failure or congestion/failure recovery, the status report comprising information about one or more affected Public Land Mobile Network Identity, and the status report is transmitted to the Multi-cell/multicast Coordination Entity.

Further, according to certain embodiments of the present invention in regard of the first and second aspect, the information indicating the one or more supported Public Land Mobile Network Identities for the at least one Multimedia Broadcast Multicast Service Service Area Identity is transmitted to a Multi-cell/multicast Coordination Entity and/or to another base station and/or to a user equipment.

Further, certain embodiments of the present invention in regard of the third and fourth aspect may comprise receiving a Multimedia Broadcast Multicast Service session control message from the Mobility Management Entity, determining the involved base station based on the one or more Public Land Mobile Network Identities indicated in the received Multimedia Broadcast Multicast Service session control message, and the one or more Public Land Mobile Network Identities supported by the respective base station, and transmitting a Multimedia Broadcast Multicast Service session control message to the involved base station.

Further, according to certain embodiments of the present invention in regard of the third and fourth aspect, information indicating supported one or more Public Land Mobile Network Identities from the Mobility Management Entity is received, a status report from the base station in case of an error during Multimedia Broadcast Multicast Service session start or in case of a detected congestion/failure or congestion/failure recovery is received, the status report comprising information about one or more affected Public Land Mobile Network Identities, the status report is filtered based on the one or more Public Land Mobile Network Identities supported by the core network, and the status report is transmitted to the core network.

Further, according to certain embodiments of the present invention in regard of the fifth and sixth aspect, information indicating the one or more supported Public Land Mobile Network Identities is transmitted to the Multi-cell/multicast Coordination Entity.

Moreover, according to certain embodiments of the invention, the term message as used in the above aspects and claims refers to a setup request message and/or a configuration update message.

### BRIEF DESCRIPTION OF DRAWINGS

For a more complete understanding of example embodiments of the present invention, reference is now made to the following descriptions taken in connection with the accompanying drawings in which:

FIG. 1 schematically shows a reference architecture for EPS MBMS according to the prior art as specified in document 3GPP TS23.246;

FIG. 2 shows a session start procedure for an MBMS session according to 3GPP specifications as defined in 3GPP TS36.300;

FIG. 3a illustrates a Gateway Core Network (GWCN) configuration for network sharing according to the prior art as specified in 3GPP TS23.251;

FIG. 3b illustrates a Multi-Operator Core Network (MOCN) in which multiple CN nodes are connected to the same RNC and the CN nodes are operated by different operators according to 3GPP TS23.251;

FIGS. 4a to 4c schematically illustrate methods according to certain embodiments of the invention;

FIGS. 5a to 5c schematically show apparatuses according to certain embodiments of the present invention;

FIG. 6 schematically illustrates an example for network sharing for MBMS;

FIG. 7 shows an example for network sharing for MBMS for a specific cell;

FIG. 8 shows MBMS Session Control signaling which is sent to incorrect MCE/eNB;

FIG. 9a shows network sharing for MBMS without implementation of RAN sharing;

FIG. 9b shows network sharing for MBMS with implementation of RAN sharing; and

FIG. 10 shows a call flow for network sharing according to certain embodiments of the present invention.

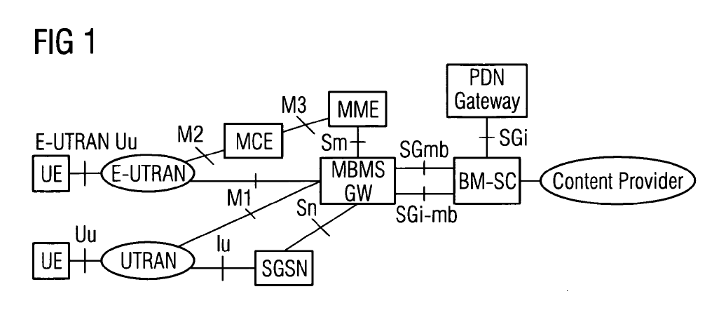

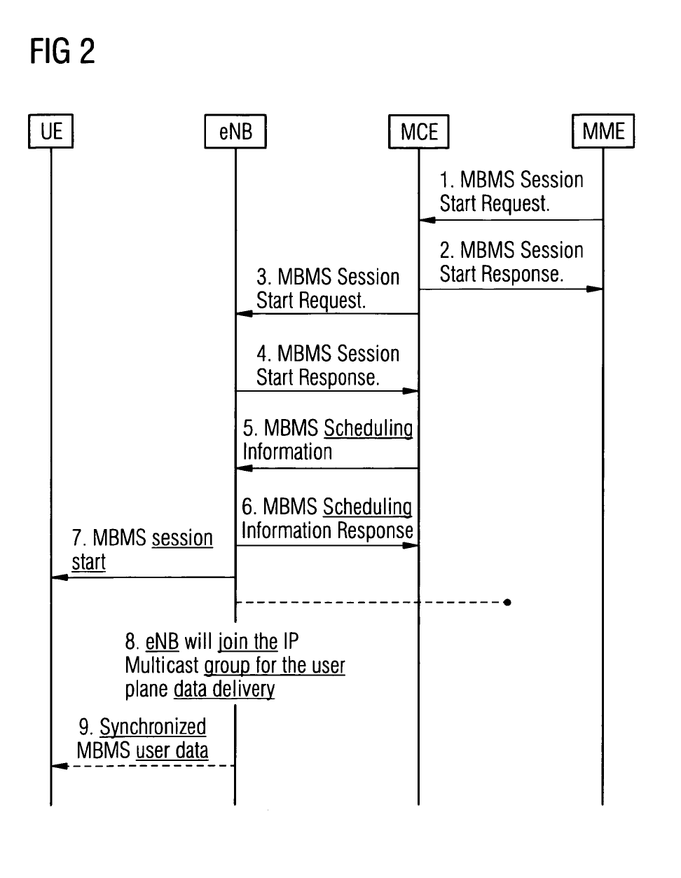

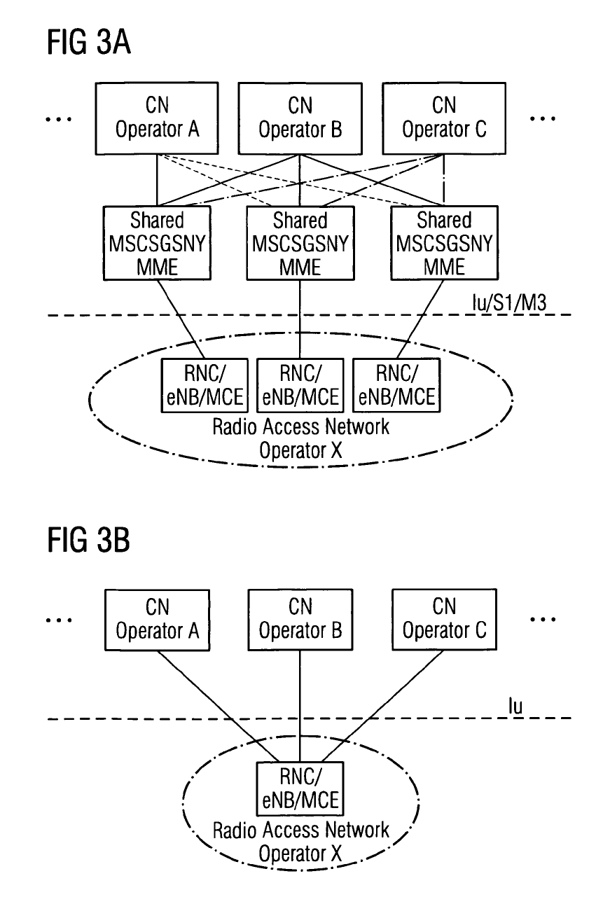

### DESCRIPTION OF EXEMPLARY EMBODIMENTS

Exemplary aspects of the present invention will be described herein below. More specifically, exemplary aspects of the present invention are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

Some example versions of the disclosure and embodiments are described with reference to the drawings. In the following, different exemplifying examples will be described using, as an example of a communication network, a cellular wireless communication network, such as an LTE or LTE-Advanced based system. However, it is to be noted that the present invention is not limited to an application using such types of communication system, but is also applicable in other types of communication systems, be it wireless systems, wired systems or systems using a combination thereof.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

In particular, the following examples versions and embodiments are to be understood only as illustrative examples. Although the specification may refer to “an”, “one”, or “some” example version(s) or embodiment(s) in several locations, this does not necessarily mean that each such reference is to the same example version(s) or embodiment(s), or that the feature only applies to a single example version or embodiment. Single features of different embodiments may also be combined to provide other embodiments. Furthermore, words “comprising” and “including” should be understood as not limiting the described embodiments to consist of only those features that have been mentioned and such example versions and embodiments may also contain also features, structures, units, modules etc. that have not been specifically mentioned.

In general, a telecommunication network comprises plural network elements, such as base stations BS, evolved NodeB's (eNB; i.e. base station in LTE environment), user equipments UE (e.g. mobile phone, smart phone, Computer, etc.), controllers, interfaces, etc, and in particular any equipment used in the provision of a telecommunications service.

A basic system architecture of a communication system where example versions and embodiments are applicable may comprise a commonly known architecture of one or more communication networks comprising a wired or wireless access network subsystem and a core network. Such an architecture may comprise one or more communication network control elements, access network elements, radio access network elements, access service network gateways or base transceiver stations, such as a base station, an access point or an eNB, which control a respective coverage area or cell (macro cell, small cell) and with which one or more communication elements or terminal devices such as a UE or another device having a similar function, such as a modem chipset, a chip, a module etc., which can also be part of a UE or attached as a separate element to a UE, or the like, are capable to communicate via one or more channels for transmitting several types of data. Furthermore, core network elements such as gateway network elements, policy and charging control network elements, mobility management entities, operation and maintenance elements, and the like may be comprised.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from a base station and a communication network besides those described in detail herein below.

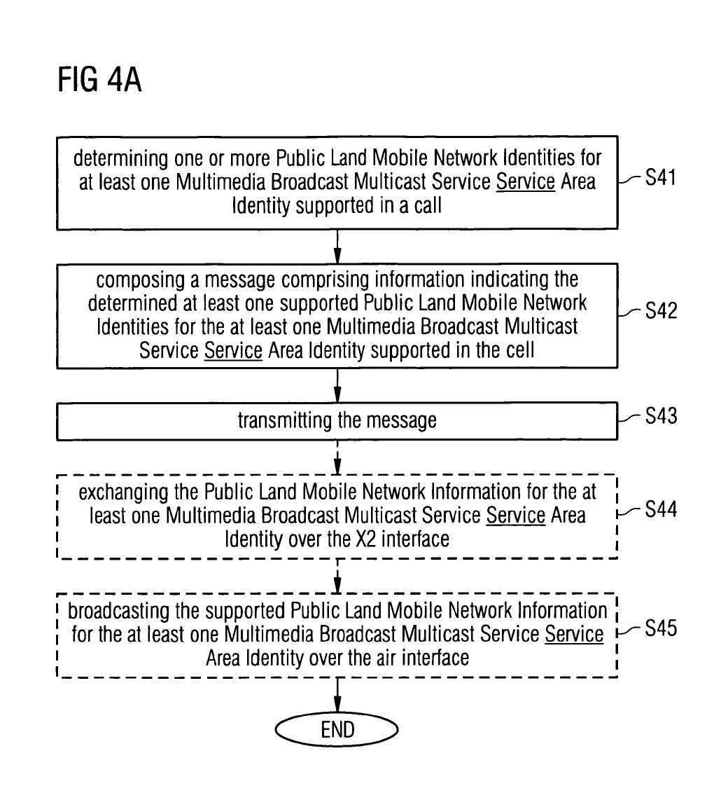

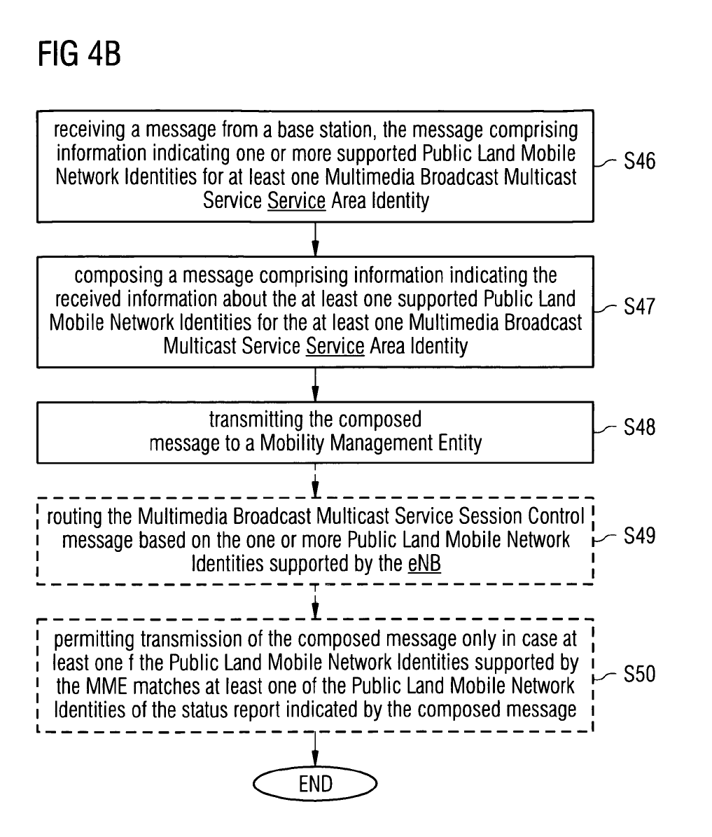

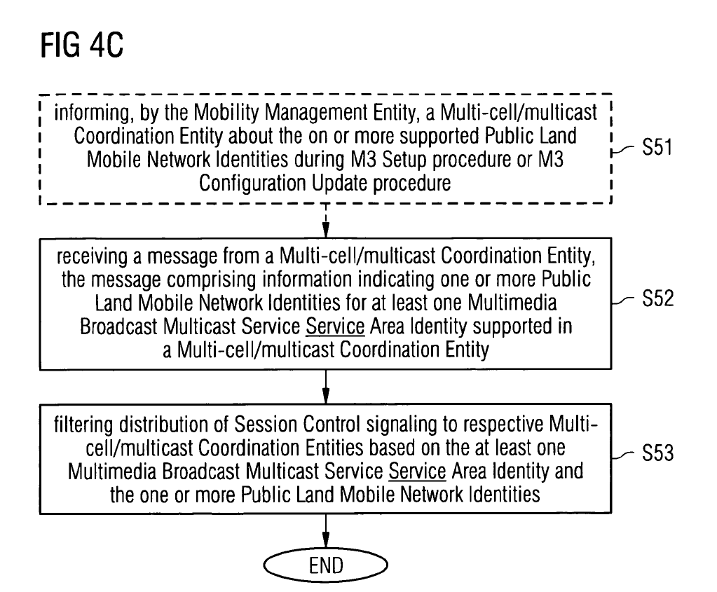

FIG. 4a shows a method according to some example versions of the disclosure, which may be performed by a base station of a mobile network.

In Step S41, one or more Public Land Mobile Network Identities for at least one Multimedia Broadcast Multicast Service Service Area Identity supported in a cell are determined.

Then, in Step S42, a message, such as a setup request message or configuration update message, comprising information indicating the determined one or more supported Public Land Mobile Network Identities for the at least one Multimedia Broadcast Multicast Service Service Area Identity supported in the cell is composed.

Further, in Step S43, the message is transmitted, e.g. to a Multi-cell/multicast Coordination Entity as one example.

Optionally, as is depicted by dashed boxes in FIG. 4a, in Step S44 the PLMN Information for at least one MBMS SAI may be exchanged over the X2 interface, and in Step S45, the supported PLMN Information for at least one MBMS SAI is broadcasted over the air interface.

FIG. 4b shows a method according to some example versions of the disclosure, which may be performed by a Multi-cell/multicast Coordination Entity.

In Step S46, a first message, such as a setup request message or configuration update message, is received from a base station, the message comprising information indicating one or more supported Public Land Mobile Network Identities for at least one Multimedia Broadcast Multicast Service Service Area Identity.

Then, in Step S47, a second message, such as a setup request message or configuration update message, comprising information indicating the received information about the one or more supported Public Land Mobile Network Identities for the at least one Multimedia Broadcast Multicast Service Service Area Identity is composed.

Further, in Step S48, the composed message is transmitted to a Mobility Management Entity.

Optionally, as is depicted by dashed boxes in FIG. 4b, in Step S49, the MBMS Session Control message is routed based on the one or more PLMN IDs supported by the eNB, and in Step S50, the status report is sent to MME based on the PLMN ID check. That is, the status report is filtered based on the PLMN supported by MME, and transmission of the composed message is only permitted in case at least one of the one or more Public Land Mobile Network Identities supported by the Mobility Management Entity matches at least one of the Public Land Mobile Network Identities of the status report indicated by the composed message.

FIG. 4c shows a method according to some example versions of the disclosure, which may be performed by a Mobility Management Entity.

According to optional Step S51, as is depicted by a dashed box, the MME informs the MCE about the supported one or more PLMN IDs during M3 Setup procedure or M3 Configuration Update procedure.

In Step S52, a message, such as a setup request message or a configuration update message, is received from a Multi-cell/multicast Coordination Entity, the message comprising information indicating one or more Public Land Mobile Network Identities for at least one Multimedia Broadcast Multicast Service Service Area Identity supported in a Multi-cell/multicast Coordination Entity.

Then, in Step 53 distribution of Session Control signaling to respective Multi-cell/multicast Coordination Entities is filtered based on the at least one Multimedia Broadcast Multicast Service Service Area Identity and the one or more Public Land Mobile Network Identities.

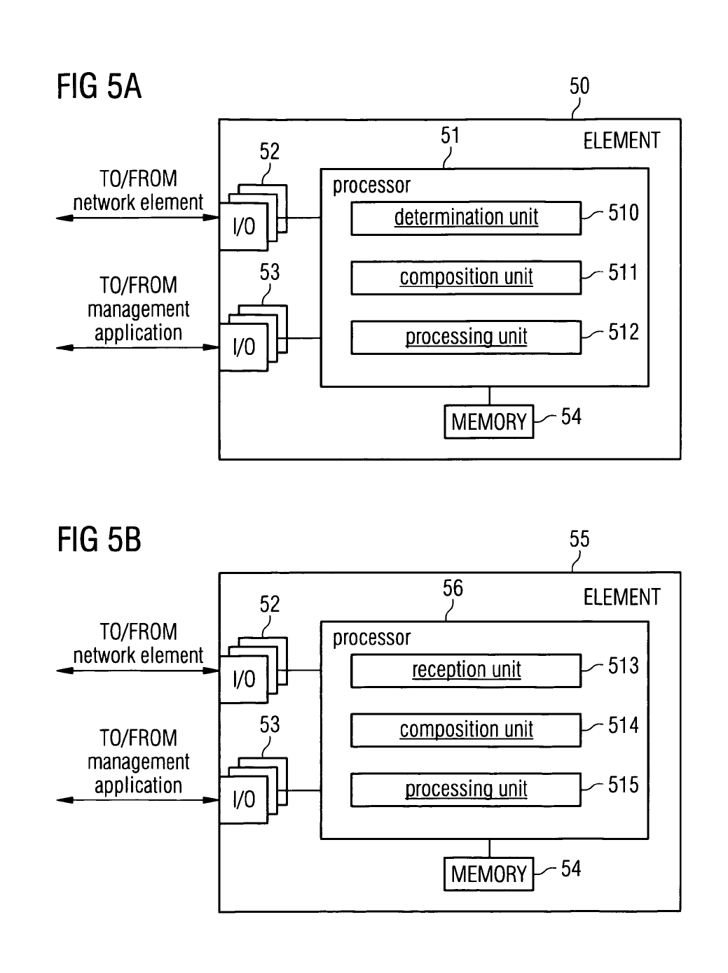

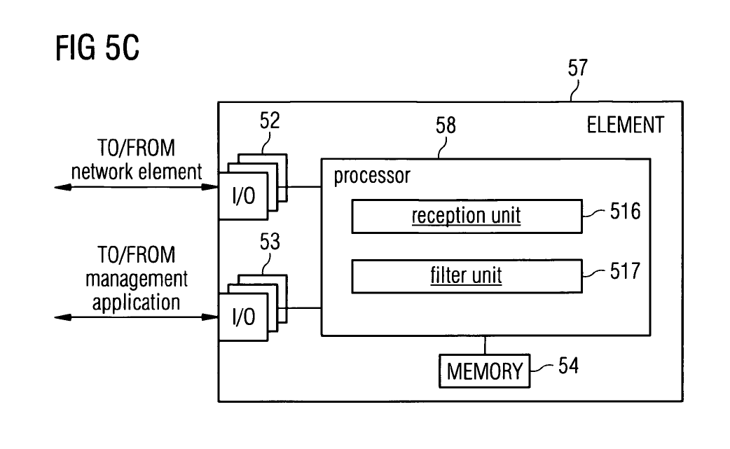

In FIG. 5a, a diagram illustrating a configuration of an element comprised in a base station of a mobile network of a communication network according to some example versions of the disclosure is shown, which is configured to implement network sharing with Multimedia Broadcast Multicast Service as described in connection with some of the example versions of the disclosure.

The element 50 shown in FIG. 5a may comprise a processing function, control unit or processor 51, such as a CPU or the like, which is suitable for executing instructions given by programs or the like related to the network element control procedure. The processor 51 is configured to execute processing related to the above described network sharing with Multimedia Broadcast Multicast Service. In particular, the processor 51 comprises a sub-portion 510 as a determination unit configured to determine one or more Public Land Mobile Network Identities for at least one Multimedia Broadcast Multicast Service Service Area Identity supported in a cell. The portion 510 may be configured to perform processing according to S41 of FIG. 4a. Furthermore, the processor 51 comprises a sub-portion 511 usable as a composition unit configured to compose a message comprising information indicating the determined one or more supported Public Land Mobile Network Identities for the at least one Multimedia Broadcast Multicast Service Service Area Identity supported in the cell. The portion 511 may be configured to perform processing according to S42 of FIG. 4a. Furthermore, the processor 51 comprises a sub-portion 512 usable as a processing unit configured to cause transmission of the message, e.g. to a Multi-cell/multicast Coordination Entity. The portion 512 may be configured to perform processing according to S43 of FIG. 4a. The processor may also be adapted to perform the processing according to Step S44 and/or S45 of FIG. 4a.

The diagram in FIG. 5b illustrates a configuration of an element comprised in a Multi-cell/multicast Coordination Entity of a mobile network of a communication network according to some example versions of the disclosure, which is configured to implement network sharing with Multimedia Broadcast Multicast Service as described in connection with some of the example versions of the disclosure.

The element 55 shown in FIG. 5b may comprise a processing function, control unit or processor 56, such as a CPU or the like, which is suitable for executing instructions given by programs or the like related to the network element control procedure. The processor 56 is configured to execute processing related to the above described network sharing with Multimedia Broadcast Multicast Service. In particular, the processor 56 comprises a sub-portion 513 as a reception unit configured to receive a message from a base station, the message comprising information indicating one or more supported Public Land Mobile Network Identities for at least one Multimedia Broadcast Multicast Service Service Area Identity. The portion 513 may be configured to perform processing according to S46 of FIG. 4b. Furthermore, the processor 56 comprises a sub-portion 514 usable as a composition unit configured to compose a message comprising information indicating the received information about the one or more supported Public Land Mobile Network Identities for the at least one Multimedia Broadcast Multicast Service Service Area Identity. The portion 514 may be configured to perform processing according to S47 of FIG. 4b. Furthermore, the processor 56 comprises a sub-portion 515 usable as a processing unit configured to cause transmission of the composed message to a Mobility Management Entity. The portion 515 may be configured to perform processing according to S48 of FIG. 4b. The processor may also be adapted to perform the processing according to Step S49 and/or S50 of FIG. 4b.

The diagram shown in FIG. 5c illustrates a configuration of an element comprised in a Mobility Management Entity of a mobile network of a communication network according to some example versions of the disclosure, which is configured to implement network sharing with Multimedia Broadcast Multicast Service as described in connection with some of the example versions of the disclosure.

The element 57 shown in FIG. 5c may comprise a processing function, control unit or processor 58, such as a CPU or the like, which is suitable for executing instructions given by programs or the like related to the network element control procedure. The processor 58 is configured to execute processing related to the above described network sharing with Multimedia Broadcast Multicast Service. In particular, the processor 58 comprises a sub-portion 516 as a reception unit configured to receive a message from a Multi-cell/multicast Coordination Entity, the message comprising information indicating one or more Public Land Mobile Network Identities for at least one Multimedia Broadcast Multicast Service Service Area Identity supported in a Multi-cell/multicast Coordination Entity. The portion 516 may be configured to perform processing according to S52 of FIG. 4c. Furthermore, the processor 58 comprises a sub-portion 517 usable as a filter unit configured to filter distribution of Session Control signaling to respective Multi-cell/multicast Coordination Entities based on the at least one Multimedia Broadcast Multicast Service Service Area Identity and the one or more Public Land Mobile Network Identities. The portion 517 may be configured to perform processing according to S53 of FIG. 4c. The processor may also be adapted to perform the processing according to Step S51 of FIG. 4c.

Reference signs 52 and 53 in each of FIGS. 5a to 5c denote transceiver or input/output (I/O) units (interfaces) connected to the processor 51, 56, 58. The I/O units 52 may be used for communicating with the element. The I/O units 53 may be used for communicating with a management application. Reference sign 54 denotes a memory usable, for example, for storing data and programs to be executed by the processor 51, 56, 58 and/or as a working storage of the processor 51, 56, 58.

It is to be noted that the above elements 50, 55 and 57 may comprise elements or functions, such as a chipset, a chip, a module etc., which can also be part of a network element or attached as a separate element to a network element, or the like. It should be understood that each block and any combination thereof may be implemented by various means or their combinations, such as hardware, software, firmware, one or more processors and/or circuitry.

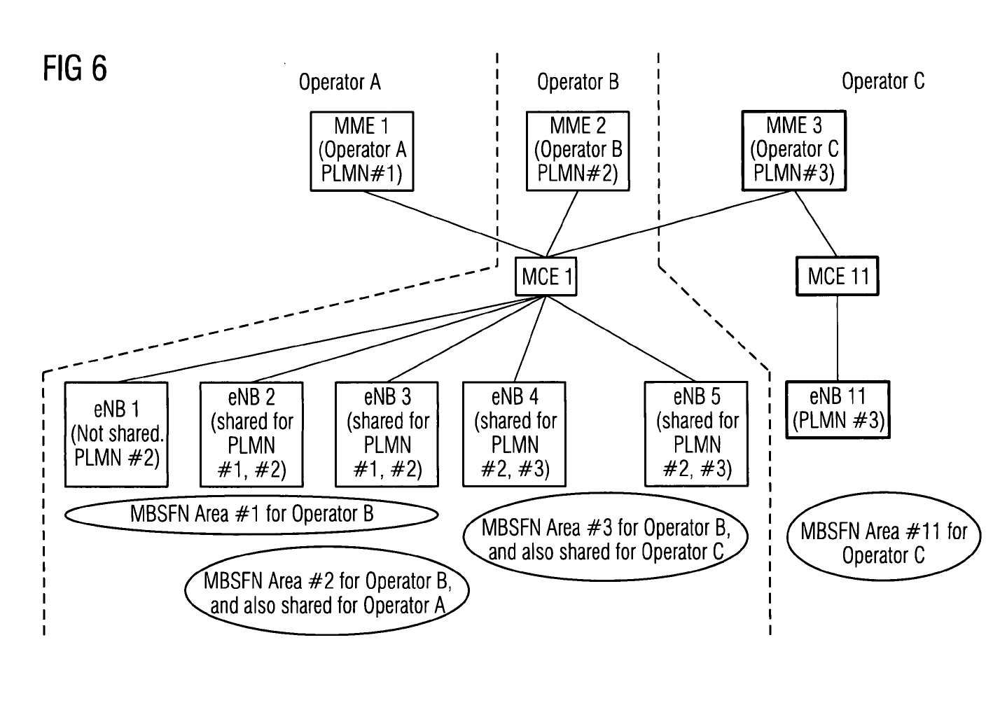

FIG. 6 shows an MOCN example for network sharing for MBMS. Three operators, i.e. Operator A with PLMN #1, Operator B with PLMN #2, and Operator C with PLMN #3 are provided in the example. The base stations eNB1 to eNB5 belong to Operator B. According to the depicted example, eNB1 is not shared, while eNB2 and eNB3 are shared with Operator A. Further, eNB4 and eNB5 are shared with Operator C. The base station eNB11 belongs to Operator C. It is not shared.

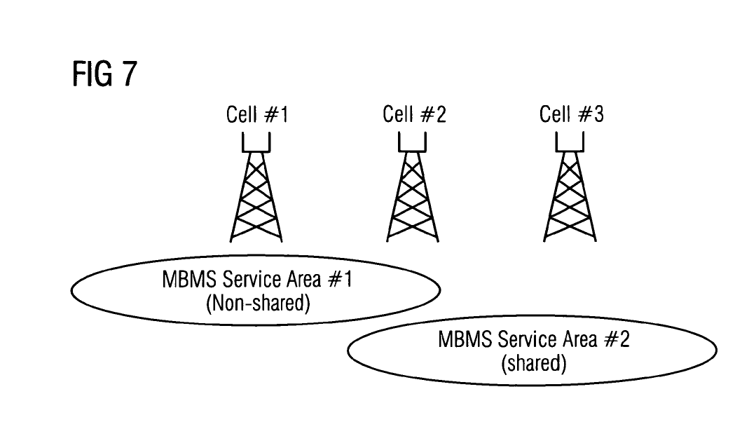

FIG. 7 shows an example for network sharing for MBMS for a specific cell. A cell shall be able to belong to one or more MBMS Service Areas (SAs). It is possible that only one or some MBMS Service Areas are shared. For example, in example shown in FIG. 7, cell #2 belongs to both MBMS Service Area #1 and #2, but only MBMS Service Area #2 is shared.

As already indicated above, the MBMS SAI is unique within a PLMN. Even if the operators may coordinate the MBMS SAIs for the shared MBMS service area, it is not required for operators to coordinate all MBMS SAIs for those non-shared MBMS service area.

In the following, some problem cases relating network sharing for MBMS which are to be improved by the present invention are described.

A first case relates to the event when a MBMS Session Control signalling is sent to an incorrect MCE/eNB

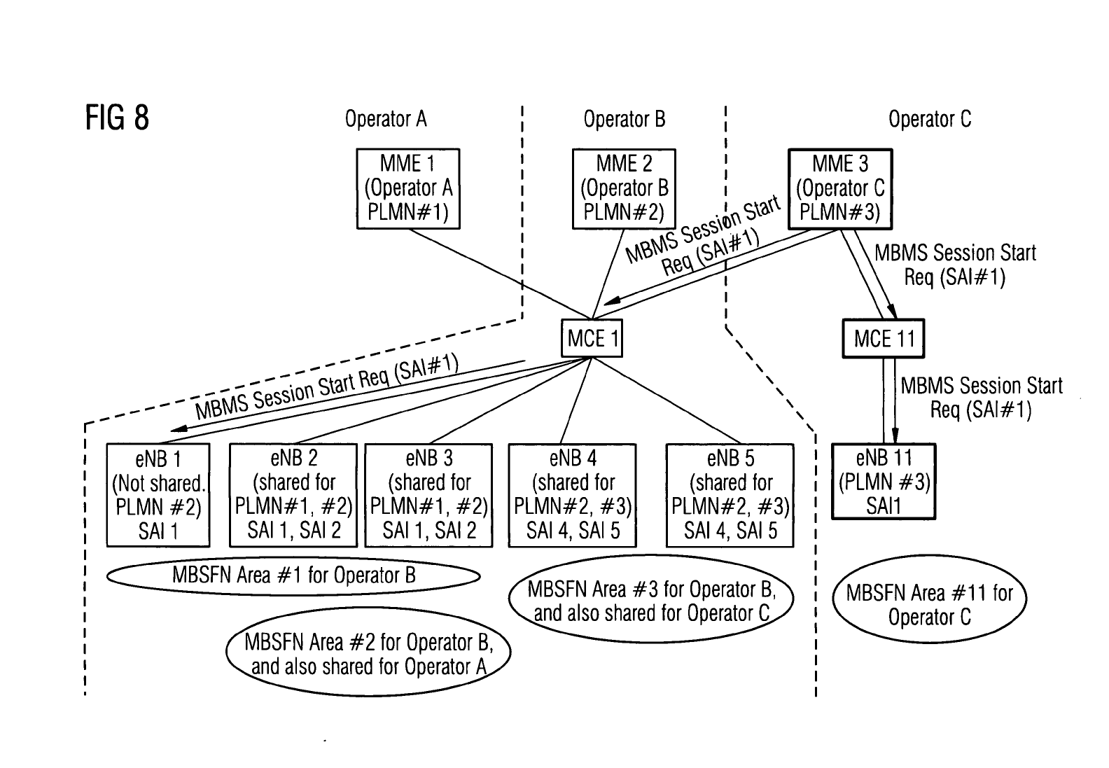

In the example shown in FIG. 8, Operator B and Operator C may assign a same MBMS SAI to their eNB, i.e. SAI1 for eNB1 in Operator B's network, and eNB11 in Operator C's network. The MME3 in Operator C's network receives M3 SETUP REQUEST from MCE1, which indicates the support for SAI1. MME3 does not know eNB1 is not shared. Later on, when MME3 receive a MBMS Session Control signalling targeting SAI1, MME3 will incorrectly forward it to MCE1, and MCE1 will incorrectly forward it to eNB1.

According to the prior-art, the MCE may pre-empt ongoing MBMS services for the new MBMS service. In case the new MBMS service has higher priority, the MCE may incorrectly pre-empt the ongoing MBMS services. In above example, MCE1 may incorrectly pre-empt the ongoing MBMS services in order to accept the new MBMS service.

The MCE may finally know it is a mistake after eNB1 rejects the MBMS Session Control signaling, but this is too late since the ongoing MBMS services have already been suspended. In addition, there is no specific cause value that can be used to inform MCE about the reason.

According to a still further case, an incorrect status reporting is issued. That is, when the Group Call eMBMS congestion management is supported, the MCE, i.e. MCE1, will incorrectly forward the eNB1's status information to MME3 since MCE does not know eNB1 is not shared. As a result, the MME3 and the core network in Operator C may take incorrect actions, for example, incorrectly move the GCSE service to unicast, or move the GCSE service back to MBMS, etc.

A still further case relates to incorrect eNB behavior for MBMS Service Continuity. That is, current MBMS SAI information is exchanged between eNBs over the X2 interface. The cell broadcasts the MBMS SAIs supported in neighboring cell via SIB15. Without knowing the supported PLMN for the MBMS SAI, the eNB may make incorrect decision to move the UE to a cell not support the target operator. The UE can also make a wrong decision if no related PLMN information for the MBMS SAI.

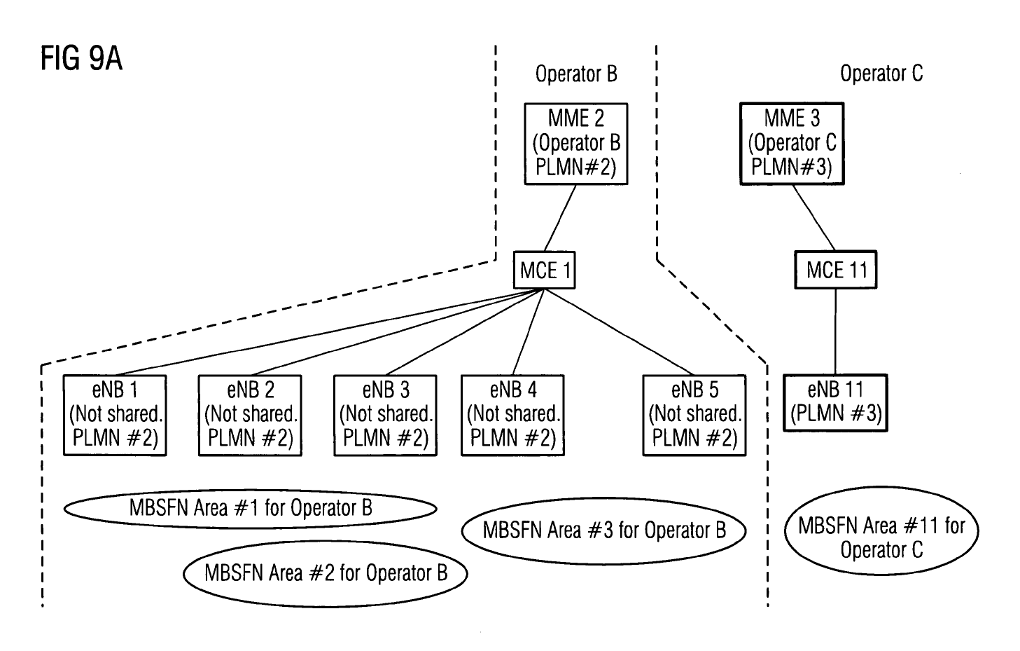

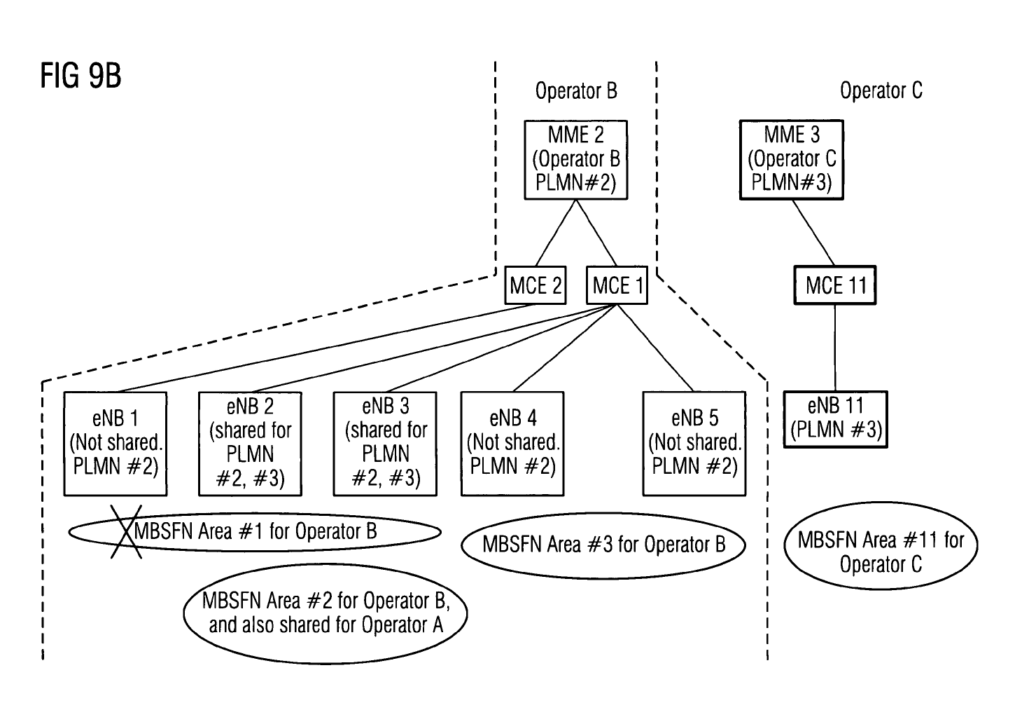

However, there may be some alternatives. On the one hand, separate MCEs may be used to serve shared eNBs, and non-shared eNBs. Without the RAN sharing has been established, as is depicted in FIG. 9a, eNB1, eNB2 and eNB3 belong to MBSFN area #1. Operator B now has agreement with Operator C to share eNB2 and eNB3. If using separate MCE for shared eNB, Operator B need to configure eNB1 connecting to MCE2. This will destroy the MBSFN area #1, since an eNB is served by a single MCE and a MBSFN area is only controlled by one MCE.

On the other hand, as is the case with RAN sharing has been established, as depicted in FIG. 9b, the MBMS SAI may be split between Operators. That is, operator C shall not use the same MBMS SAI used in Operator B's network, not just for the shared MBMS service area, but also for non-shared MBMS service area. This may significantly reduce the MBMS SAI space to be used for an operator. This also does not work for SAI0, which shall be supported by both operators. When Operator C initiates a MBMS session signaling with SAI0, it is still sent to operator B's MCE and eNBs. Nevertheless, the issues according to the above-mentioned problem cases still exist.

Therefore, according to certain embodiments of the present invention, a mechanism that allows for the information relating to the different IDs used to be provided from a eNB to a Multi-cell/multicast coordination entity (MCE) is provided, so that the appropriate routing can be determined. In addition, the Multi-cell/multicast coordination entity may also provide the mobility management entity with this information so that control signaling can be properly distributed based on the SAIs. According to certain embodiments of the present invention, an eNB indicates the PLMN for at least one MBMS SAI to the MCE. In this way, the confusion caused when the same SAI is used by multiple operators can be avoided.

In particular, according to certain embodiments of the present invention, an eNB indicates the supported one or more PLMN IDs for at least one MBMS SAI to MCE, so that the MCE can use the supported PLMN information when needs to determine the involved eNBs for routing the further MBMS Session Control signaling.

Further, according to certain embodiments, the MCE indicates the supported one or more PLMN IDs for at least one MBMS SAI to the MME.

Still further, according to certain embodiments, the MME filters the distribution of Session Control signaling to the MCEs based on the MBMS service area and the one or more PLMN IDs.

Then, according to certain embodiments, the supported PLMN information may be exchanged for at least one MBMS SAI, e.g. over the X2 interface.

Further, certain embodiments of the present invention include indicating the supported one or more PLMN IDs information for at least one MBMS SAI over the air interface.

Then, according to certain embodiments, the MME informs MCE about its supported one or more PLMN IDs.

Additionally, according to certain embodiments, the eNB includes the affected PLMN IDs in the status report to MCE, which is further sent to core network.

Thereby, the present invention provides the advantage of truly supporting the network sharing for MBMS without any restriction to operator's deployment.

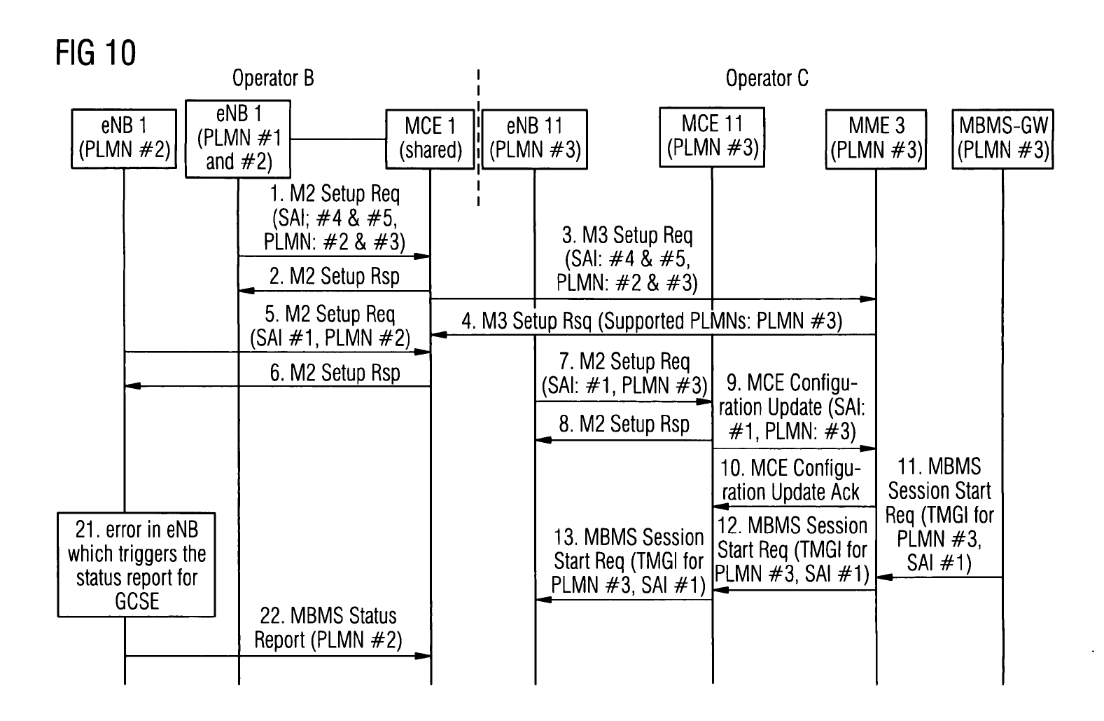

In order to establish substantiated understanding of the present invention, a detailed description of an exemplary implementation of certain embodiments of the present invention is provided in the following. FIG. 10 provides one example implementation based on a call flow according to certain embodiments of the present invention. It is to be noted that the bold and italic formatted elements indicate the new and/or enhanced content in view of the current 3GPP LTE specification.

In the example implementation shown in FIG. 10, an operator B and an operator C are provided, wherein the call flow between an eNB1, an eNB4 and MCE1 of operator B, as well as between an eNB11 and a MCE11, as well as a MME3 and a MBMS-Gateway of Operator C is depicted.

In the following, the messages transmitted in the call flow of FIG. 10 are described, and in case the respective Information Element IE comprises enhancements according to certain embodiments of the invention, an exemplary implementation of the respective enhanced IE is provided. As in the call flow of FIG. 10, the bold and italic formatted elements in the below enhanced IEs indicate the new and/or enhanced content in view of the current 3GPP LTE specification.

The messages transmitted in the exemplary call flow of FIG. 10 are as follows:

1. A shared eNB4, i.e. eNB4, initiates a M2 setup with MCE1. The M2 SETUP REQUEST message is enhanced to include the supported one or more PLMN IDs for at least one MBMS SAI. A possible enhancement (highlighted in bold and italic letters) to eNB MBMS Configuration data item IE is shown as below. It is to be noted that this Information Element IE provides MBMS related configuration information from the eNB.

Enhanced IE: eNB MBMS Configuration data Item

| | | | IE type and | Semantics |
|---|---|---|---|---|
| IE/Group Name | Presence | Range | reference | description |
| E-UTRAN CGI | M | | 9.2.1.11 | |
| MBSFN Synchronisation | M | | 9.2.1.20 | |
| Area Id | | | | |
| MBMS Service Area List | | 1 | | |
| >MBMS Service Area | | 1 to | | |
| Item | | <maxnoofMBMSServiceAreasPerCell> | | |
| >>MBMS Service Area | M | | 9.2.3.6 | |
| Supported PLMN List | | 0 . . . 1 | | |
| >Supported PLMN per | | 1 to | | |
| MBMS SAI Item | | <maxnoofMBMSServiceAreasPerCell> | | |
| >>Supported PLMNs | | 1 . . . <maxnoofSPLMNs> | | Supported |
| | | | | PLMNs |
| >>>PLMN ID | M | | 9.2.3.7 | |

Another implementation could be adding the list of one or more PLMN IDs per cell basis, or per eNB basis in the M2 Setup Request message, or the M2 eNB Configuration Update message.

2. The MCE1 replies with a M2 SETUP RESPONSE.

3. The MCE1 initiates M3 Setup with MME3. The M3 SETUP REQUEST message is enhanced to include the supported one or more PLMN IDs for at least one MBMS SAI. A possible enhancement to M3 SETUP REQUESTUEST message is shown as below. It is to be noted that this message is sent by the MCE to transfer information for a TNL association.

Enhanced IE: SETUP REQUEST
Direction: MCE → MME.

| | | | IE type and | Semantics | | Assigned |
|---|---|---|---|---|---|---|
| IE/Group Name | Presence | Range | reference | description | Criticality | Criticality |
| Message Type | M | | 9.2.1.1 | | YES | reject |
| Global MCE ID | M | | 9.2.1.10 | | YES | reject |
| MCE Name | O | | PrintableString | | YES | ignore |
| | | | (1 . . . 150, . . .) | | | |
| MBMS Service | | 1 | | | YES | reject |
| Area List | | | | | | |
| >MBMS Service | | 1 to | | Supported | GLOBAL | reject |
| Area List Item | | <maxnoofMBMSServiceAreaIdentitiesPerMCE> | | MBMS | | |
| | | | | Service Area | | |
| | | | | Identities in | | |
| | | | | the MCE | | |
| >>MBMS | M | | OCTET | MBMS | | |
| Service Area 1 | | | STRING(2) | Service Area | | |
| | | | | Identities as | | |
| | | | | defined in | | |
| | | | | TS 23.003 | | |
| | | | | [13]. | | |
| Supported PLMN | | 0 . . . 1 | | | | |
| List | | | | | | |
| > Supported | M | 1 to | | | | |
| PLMN per MBMS | | <maxnoofMBMSServiceAreaIdentitiesPerMCE> | | | | |
| SAI Item | | | | | | |
| >>Supported | | 1 . . . <maxnoofSPLMNs> | | Supported | | |
| PLMNs | | | | PLMNs | | |
| >>>PLMN | M | | 9.2.3.7 | | | |
| ID | | | | | | |

Another implementation could be adding the list of one or more PLMN IDs per cell basis, or per eNB basis in the M3 Setup Request message, or the M3 eNB Configuration Update message

4. MME3 accepts the M3 Setup and replies with M3 SETUP RESPONSE. According to certain embodiments of the present invention, the M3 SETUP RESPONSE message is enhanced to include the supported one or more PLMN IDs of the MME. A possible enhancement to M3 SETUP RESPONSE is shown as below. It is to be noted that this message is sent by the MME to tranfer information for a TNL association.

Enhanced IE: M3 SETUP RESPONSE
Direction: MME → MCE.

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | | 9.2.1.1 | YES | reject |
| Criticality | O | | 9.2.1.7 | YES | ignore |
| Diagnostics | | | | | |
| Served PLMNs | | 1 . . . <maxnoofSPLMNs> | | YES | ignore |
| >PLMN ID | M | | 9.2.3.7 | | |

5. A non-shared eNB, i.e. eNB1, initiates M2 Setup procedure. The eNB11 indicates the support of PLMN #2 for SAI #1.

6. The MCE1 accepts the M2 setup. Since MCE1 knows MME3 does not support PLMN #2, MCE1 will not initiate the M3 Configuration Update procedure to MME3.

7. The eNB11 initiates M2 Setup with MME3. eNB11 indicates the support of PLMN #3 for SAI #1.

8. The MME3 accepts the M2 Setup.

9. In case MCE11 already setup M3 with MME3, MCE11 initiates MCE CONFIGURATION UPDATE procedure. The MCE CONFIGURATION UPDATE message is enhanced to include the supported one or more PLMN IDs for at least one MBMS SAI.

A possible enhancement to MCE CONFIGURATION UPDATE is shown as below. It is to be noted that this message is sent by the MCE transfer updated information for a TNL association.

Enhanced IE: MCE CONFIGURATION UPDATE
Direction: MCE → MME.

| | | | IE type and | Semantics | | Assigned |
|---|---|---|---|---|---|---|
| IE/Group Name | Presence | Range | reference | description | Criticality | Criticality |
| Message Type | M | | 9.2.1.1 | | YES | reject |
| Global MCE ID | O | | 9.2.1.10 | | YES | reject |
| MCE Name | O | | PrintableString | | YES | ignore |
| | | | (1 . . . 150, . . .) | | | |
| MBMS Service | | 0 . . . 1 | | | YES | reject |
| Area List | | | | | | |
| >MBMS | | 1 to | | Supported | GLOBAL | reject |
| Service Area | | <maxnoofMBMSServiceAreaIdentitiesPerMCE> | | MBMS | | |
| List Item | | | | Service Area | | |
| | | | | Identities in | | |
| | | | | the MCE | | |
| >>MBMS | M | | OCTET | MBMS | | |
| Service Area | | | STRING(2) | Service Area | | |
| 1 | | | | Identities as | | |
| | | | | defined in | | |
| | | | | TS 23.003 | | |
| | | | | [13]. | | |
| Supported | | 0 . . . 1 | | | | |
| PLMN List | | | | | | |
| > Supported | | 1 to | | | | |
| PLMN per | | <maxnoofMBMSServiceAreaIdentitiesPerMCE> | | | | |
| MBMS SAI Item | | | | | | |
| >>Supported | | 1 . . . <maxnoofSPLMNs> | | Supported | | |
| PLMNs | | | | PLMNs | | |
| >>>PLMN ID | M | | 9.2.3.7 | | | |

Another implementation could be adding the list of one or more PLMN IDs per MCE basis, i.e. the list of one or more PLMN IDs apply to all MBMS SAIs, in the M3.

10. The MME3 accepts the MCE CONFIGURATION UPDATE.

11. The MBMS-GW initiates the MBMS Session Start with TMGI indicating PLMN #3, and the service area is SAI#1.

Upon the reception of the MBMS SESSION START REQUEST message, MME3 checks the PLMN ID field of the TMGI, and only forward the message to those MCEs that support the indicated PLMN and MBMS SAI. In this example, MME3 only forwards the MBMS SESSION START REQUEST message to MCE11, which is different to current filtering mechanisms in MME, which is only based on the MBMS service area.

12. The MCE checks the PLMN ID field of the TMGI, determines the involved eNB based on the one or more Public Land Mobile Network Identities indicated in the received MBMS Session Start Request message, and the one or more Public Land Mobile Network Identities supported by the respective eNB, and only forward the message to the involved eNB. In this example, the MCE11 only forwards the MBMS SESSION START REQUEST message to eNB11.

21. Later on, there may be an error in eNB1 for the Multimedia Broadcast Multicast Service related to SAIL

22. Then, the eNB1 send MBMS Status Report to MCE1. The message includes an IE for the related one or more PLMN IDs, i.e. PLMN #2, or an IE for TMGI which includes the one or more PLMN ID. Since MCE1 knows MME3 does not support PLMN #2, MCE1 will not forward the Status Report to MME3. In case the status report includes multiple PLMN IDs, or multiple TMGIs with different PLMN IDs, the MCE filter the status report so that the status report only contains information related to the one or more PLMN IDs of the MME. This may cause the MCE to send different Status Report to various MMEs.

According to certain embodiments of the present invention, in case of a Gateway Core-Network GWCN, the Status Report will be further be sent to the shared MME.

In the following, an example implementation for the enhancement to X2 interface and air interface according to certain embodiments of the present invention is shown. It is to be noted that the bold and italic issues indicate the new and/or enhanced features in regard to the current 3GPP LTE specification.

The below exemplary IE contains cell configuration information of a cell that a neighbor eNB may need for the X2 AP interface.

Enhanced IE: Served Cell Information

| | | | IE type and | Semantics | | Assigned |
|---|---|---|---|---|---|---|
| IE/Group Name | Presence | Range | reference | description | Criticality | Criticality |
| PCI | M | | INTEGER | Physical Cell | — | — |
| | | | (0 . . . 503, . . .) | ID | | |
| Cell ID | M | | ECGI | | — | — |
| | | | 9.2.14 | | | |
| TAC | M | | OCTET | Tracking Area | — | — |
| | | | STRING(2) | Code | | |
| Broadcast | | 1 . . . <maxnoofBPLMNs> | | Broadcast | — | — |
| PLMNs | | | | PLMNs | | |
| >PLMN Identity | M | | 9.2.4 | | — | — |
| . . . | | | | | | |
| MBMS Service | | 0 . . . | | Supported | GLOBAL | ignore |
| Area Identity | | <maxnoofMBMSServiceAreaIdentities> | | MBMS Service | | |
| List | | | | Area Identities | | |
| | | | | in the cell | | |
| >MBMS | | | OCTET | MBMS Service | | |
| Service Area | | | STRING(2) | Area Identities | | |
| Identity | | | | as defined in | | |
| | | | | TS 23.003 [29] | | |
| Supported | | 0 . . . 1 | | | | |
| PLMN List for | | | | | | |
| MBMS SAI | | | | | | |
| > Supported | | 1 to | | | | |
| PLMN per | | <maxnoofMBMSServiceAreasPerCell> | | | | |
| MBMS SAI Item | | | | | | |
| >>Supported | | | BITSTRING | Each position | | |
| PLMN Index | | | (SIZE(8)) | indicates | | |
| | | | | whether the | | |
| | | | | MBMS SAI | | |
| | | | | supports the | | |
| | | | | PLMN ID as | | |
| | | | | indicated in | | |
| | | | | Broadcast | | |
| | | | | PLMNs IE. | | |
| | | | | Value “1” | | |
| | | | | indicates | | |
| | | | | “support” and | | |
| | | | | value “0” | | |
| | | | | indicates “not | | |
| | | | | support”. | | |
| MultibandInfoList | O | | 9.2.60 | | YES | ignore |

Further, System Information Block 15 (SIB15) may be enhanced to indicate the supported one or more PLMN IDs for the Multimedia Broadcast Multicast Service, e.g. the supported one or more PLMN IDs for at least one MBMS SAI, or for all MBMS SAIs of the cell.

To summarize, the present invention relates to network sharing with MBMS. In mobile networks, MBMS service area identities (SAIs) are unique and while some coordination of SAIs is possible (for example in shared MBMS service areas), problems can occur when coordinating shared and non-shared MBMS service areas, as SAIs used in different networks but have identical values can cause routing problems, as the destination can be unclear due a mix up caused by multiple identical SAIs. The present invention provides a mechanism that allows for the information relating to the different IDs used to be provided from an eNB to a Multi-cell/multicast Coordination Entity (MCE) so that the appropriate routing can be determined. In addition, the Multi-cell/multicast Coordination Entity may also provide the Mobility Management Entity with this information so that control signaling can be properly distributed based on the SAIs. In this way, there would be no confusion if the same SAI is used by multiple operators.

It is to be noted that embodiments of the present invention may be implemented as circuitry, in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The present invention relates in particular but without limitation to mobile communications, for example to environments under LTE™ or LTE-Advanced, and can advantageously be implemented also in controllers, base stations, user equipments or smart phones, or computers connectable to such networks. That is, it can be implemented e.g. as/in chipsets to connected devices.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The communication network is also able to communicate with other networks, such as a public switched telephone network or the Internet. The communication network may also be able to support the usage of cloud services. It should be appreciated that BSs and/or eNBs or their functionalities may be implemented by using any node, host, server or access node etc. entity suitable for such a usage.

Furthermore, the described network elements, such as terminal devices or user devices like UEs, communication network control elements of a cell, like a BS or an eNB, access network elements like APs and the like, as well as corresponding functions as described herein may be implemented by software, e.g. by a computer program product for a computer, and/or by hardware. In any case, for executing their respective functions, correspondingly used devices, nodes or network elements may comprise several means, modules, units, components, etc. (not shown) which are required for control, processing and/or communication/signaling functionality. Such means, modules, units and components may comprise, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means comprising e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

The following meanings for the abbreviations used in this specification apply:

3GPP 3^{rd} Generation Partnership Project

eNB evolved NodeB

EPS Evolved Packet Service

(E-)UTRAN (Evolved) Universal Terrestrial Radio Access Network

GWCN Gateway Core Network

LTE(-A) Long Term Evolution (Advanced)

MBMS Multimedia Broadcast Multicast Service

MCE Multi-cell/multicast Coordination Entity

MME Mobility Management Entity

MOCN Multi-Operator Core Network

MSC Mobile Switching Center

PLMN (ID) Public land mobile network (Identity)

RAN Radio Access Network

RNC Radio Network Controller

SAI Service Area Identity

SGSN Serving GPRS support node

TMGI temporary mobile group identity

TNL Transport Network Layer

1. A method performed in a base station of a mobile network, comprising
determining one or more Public Land Mobile Network Identities for at least one Multimedia Broadcast Multicast Service Service Area Identity supported in a cell;
composing a message comprising information indicating the determined one or more supported Public Land Mobile Network Identities for the at least one Multimedia Broadcast Multicast Service Service Area Identity supported in the cell; and
transmitting the message.

2. The method according to claim 1, further comprising composing a status report in case of an error during Multimedia Broadcast Multicast Service session start or in case of a detected congestion/failure or congestion/failure recovery, the status report comprising information about the one or more affected Public Land Mobile Network Identities; and
transmitting the status report to a Multi-cell/multicast Coordination Entity.

3. The method according to claim 1, wherein the information indicating the one or more supported Public Land Mobile Network Identities for the at least one Multimedia Broadcast Multicast Service Service Area Identity is transmitted to a Multi-cell/multicast Coordination Entity and/or to another base station and/or to a user equipment.

4. An apparatus comprised in a base station of a mobile network, comprising
a determination unit configured to determine one or more Public Land Mobile Network Identities for at least one Multimedia Broadcast Multicast Service Service Area Identity supported in a cell;
a composition unit configured to compose a message comprising information indicating the determined one or more supported Public Land Mobile Network Identities for the at least one Multimedia Broadcast Multicast Service Service Area Identity supported in the cell; and
a processing unit configured to cause transmission of the message to a Multi-cell/multicast Coordination Entity.

5. The apparatus according to claim 4, wherein
the composition unit is further configured to compose a status report in case of an error during Multimedia Broadcast Multicast Service session start or in case of a detected congestion/failure or congestion/failure recovery, the status report comprising information about one or more affected Public Land Mobile Network Identities; and
wherein the processing unit is further configured to cause transmission of the status report to a Multi-cell/multicast Coordination Entity.

6. The apparatus according to claim 4, wherein the information indicating the one or more supported Public Land Mobile Network Identities for the at least one Multimedia Broadcast Multicast Service Service Area Identity is transmitted to a Multi-cell/multicast Coordination Entity and/or to another base station and/or to a user equipment.

7. A method performed in a Multi-cell/multicast Coordination Entity, comprising receiving a message from a base station, the message comprising information indicating one or more supported Public Land Mobile Network Identities for at least one Multimedia Broadcast Multicast Service Service Area Identity;
composing a message comprising information indicating the received information about the one or more supported Public Land Mobile Network Identities for the at least one Multimedia Broadcast Multicast Service Service Area Identity; and
transmitting the composed message to a Mobility Management Entity.

8. The method according to claim 7, further comprising
receiving a Multimedia Broadcast Multicast Service session control message from the Mobility Management Entity;
determining the involved base station based on the one or more Public Land Mobile Network Identities indicated in the received Multimedia Broadcast Multicast Service session control message, and the one or more Public Land Mobile Network Identities supported by the respective base station; and
transmitting a Multimedia Broadcast Multicast Service session control message to the involved base station.

9. The method according to claim 7, further comprising
receiving information indicating supported one or more Public Land Mobile Network Identities from the Mobility Management Entity;
receiving a status report from the base station in case of an error during Multimedia Broadcast Multicast Service session start or in case of a detected congestion/failure or congestion/failure recovery, the status report comprising information about one or more affected Public Land Mobile Network Identities;
filtering the status report based on the one or more Public Land Mobile Network Identities supported by the core network; and
transmitting the status report to the core network.

10. An apparatus comprised in a Multi-cell/multicast Coordination Entity, comprising
a reception unit configured to receive a message from a base station, the message comprising information indicating one or more supported Public Land Mobile Network Identities for at least one Multimedia Broadcast Multicast Service Service Area Identity;
a composition unit configured to compose a message comprising information indicating the received information about the one or more supported Public Land Mobile Network Identities for the at least one Multimedia Broadcast Multicast Service Service Area Identity; and
a processing unit configured to cause transmission of the composed message to a Mobility Management Entity.

11. The apparatus according to claim 10, wherein
the reception unit is further configured to receive a Multimedia Broadcast Multicast Service session control message from the Mobility Management Entity, the involved base station is determined based on the one or more Public Land Mobile Network Identities indicated in the received Multimedia Broadcast Multicast Service session control message, and the one or more Public Land Mobile Network Identities supported by the respective base station, and
the processing unit is further configured to cause transmission of the Multimedia Broadcast Multicast Service session control message to the involved base station.

12. The apparatus according to claim 10, wherein
the reception unit is further configured to receive information indicating supported one or more Public Land Mobile Network Identities from the Mobility Management Entity;
the reception unit is further configured to receive a status report from the base station in case of an error during Multimedia Broadcast Multicast Service session start or in case of a detected congestion/failure or congestion/failure recovery, the status report comprising information about one or more affected Public Land Mobile Network Identities; and
the processing unit is further configured to filter the status report based on the one or more Public Land Mobile Network Identities supported by the core network and cause transmission of the status report to the core network.

13. A method performed in a Mobility Management Entity, comprising
receiving a message from a Multi-cell/multicast Coordination Entity, the message comprising information indicating one or more Public Land Mobile Network Identities for at least one Multimedia Broadcast Multicast Service Service Area Identity supported in a Multi-cell/multicast Coordination Entity; and
filtering distribution of Session Control signaling to respective Multi-cell/multicast Coordination Entities based on the at least one Multimedia Broadcast Multicast Service Service Area Identity and the one or more Public Land Mobile Network Identities.

14. The method according to claim 13, further comprising
transmitting information indicating the one or more supported Public Land Mobile Network Identities to the Multi-cell/multicast Coordination Entity.

15. An apparatus comprised in a Mobility Management Entity, comprising
a reception unit configured to receive a message from a Multi-cell/multicast Coordination Entity, the message comprising information indicating one or more Public Land Mobile Network Identities for at least one Multimedia Broadcast Multicast Service Service Area Identity supported in a Multi-cell/multicast Coordination Entity; and
a filter unit configured to filter distribution of Session Control signaling to respective Multi-cell/multicast Coordination Entities based on the at least one Multimedia Broadcast Multicast Service Service Area Identity and the one or more Public Land Mobile Network Identities.

16. The apparatus according to claim 15, further comprising
a processing unit configured to cause transmission of information indicating the one or more supported Public Land Mobile Network Identities to the Multi-cell/multicast Coordination Entity.

17. The method according to claim 1, wherein the message is a setup request message and/or a configuration update message.

18. The apparatus according to claim 4, wherein the message is a setup request message and/or a configuration update message.

19. A method performed in a user equipment, comprising
receiving an indication of one or more supported Public Land Mobile Network Identities for at least one Multimedia Broadcast Multicast Service Service Area Identity supported in at least one cell; and
taking action based on the at least one supported Multimedia Broadcast Multicast Service Service Area Identity and at least in part on the received indication of the one or more supported Public Land Mobile Network Identities.

20. An apparatus comprised in a user equipment, comprising
a reception unit configured to receive an indication of one or more supported Public Land Mobile Network Identities for at least one Multimedia Broadcast Multicast Service Service Area Identity supported in at least one cell; and
a processing unit configured to take action based on the at least one supported Multimedia Broadcast Multicast Service Service Area Identity and at least in part on the received indication of the one or more supported Public Land Mobile Network Identities.

21. A computer program product for a computer, comprising software code portions for performing the steps of claim 1 when said product is run on the computer, wherein
the computer program product comprises a non-transitory computer-readable medium on which said software code portions are stored, and/or
the computer program product is directly loadable into the internal memory of the computer and/or transmittable via a network by means of at least one of upload, download and push procedures.
